(19) United States
(12) Patent Application Publication
(10) Pub. No.: US 2004/0255793 A1
(43) Pub. Date: Dec. 23, 2004

(54) Barbecue device

(76) Inventor: Valentin Leiro Paz, Barcelona (ES)

Correspondence Address: BLANK ROME LLP, 600 NEW HAMPSHIRE AVENUE, N.W., WASHINGTON, DC, 20037, US

(21) Appl. No.: 10/824,642

(22) Filed: Apr. 15, 2004

(30) Foreign Application Priority Data
May 31, 2002 (ES) P200201258

(51) Int. Cl. A47J 9/00

(52) U.S. Cl. 99/450

(57) ABSTRACT

A barbecue device that includes a tray supporting combustible material including at least one refractory member adapted to store heat. A grill is disposed above the tray and is connected thereto by a lifting member. The lifting member includes a bar slidably received in an outer cylinder. Actuation of the bar with respect to the outer cylinder adjusts the height of grill with respect to the tray.

### CROSS-REFERENCE TO RELATED APPLICATION

This application is related to copending and commonly owned application entitled “Improved Barbecue for Food” filed May 31, 2002 (Spanish Patent Application No. P200201258), the subject matter of which is incorporated by reference in its entirety.

1. Field of the Invention

The present invention generally relates to an adjustable barbecue device. More specifically, the adjustable barbecue device provides adjustment in the amount of heat applied to foods used with the device.

2. Background of the Invention

Conventional barbecue devices use heat generated by fire for cooking foods located above the fire. Typically, the fire is provided by combustion of wood, coal or similar combustible materials placed on a tray which may be provided with holes allowing air to flow through the combustible material, thereby facilitating combustion. Conventional barbecue devices allow food to be heated directly on the device without interposing any cookware, such as griddles, skillets, and the like. Additionally, foods are cooked in a completely natural way.

However, due to the nature of the combustible materials used with the conventional barbecue device, it is often difficult to control the heat generated and applied to the food. Often the only way of preventing the food from either directly contacting the fire or receiving excessive heat is to vary the height between the food and the fire or ember produced by the combustible materials.

Some conventional barbecue devices allow adjustment of the height of the food by using a set of horizontal grooves provided in the housing of the barbecue device representing different distances between the food and the combustible material. However, over a period of time the support for the food reaches a high temperature which is dangerous to the user. This forces the user to wear gloves to operate the barbecue device when adjusting the relative height of the food. A simple mistake may cause bums to the user.

Another problem with conventional barbecue devices is adjusting the amount and duration of combustion. Combustion may vary depending upon the type of combustible materials used and the environment, such as more or less humidity. For example, the combustible material may be consumed too quickly because the material has generated all of the possible heat it can, often leaving food uncooked.

### SUMMARY OF THE INVENTION

Accordingly, an object of the present invention is to provide a barbecue device that allows adjustment of the heat applied to the food to avoid accidents.

Another object of the present invention is to provide a barbecue device that includes a residual heat source that facilitates proper heating of the food.

The foregoing objects are basically attained by a barbecue device that includes a tray supporting combustible material including at least one refractory member adapted to store heat. A grill is disposed above the tray and is connected thereto by a lifting member. The lifting member includes a bar slidably received in an outer cylinder. Actuation of the bar with respect to the outer cylinder adjusts the height of grill with respect to the tray.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

FIG. 1 is a front side elevational view of the barbecue device in accordance with an embodiment of the present invention; and

FIG. 2 is a top plan view of the barbecue device illustrated in FIG. 1, showing the barbecue device without a grill and showing refractory members supported by a tray with spaces disposed between the individual refractory members.

### DETAILED DESCRIPTION OF THE INVENTION

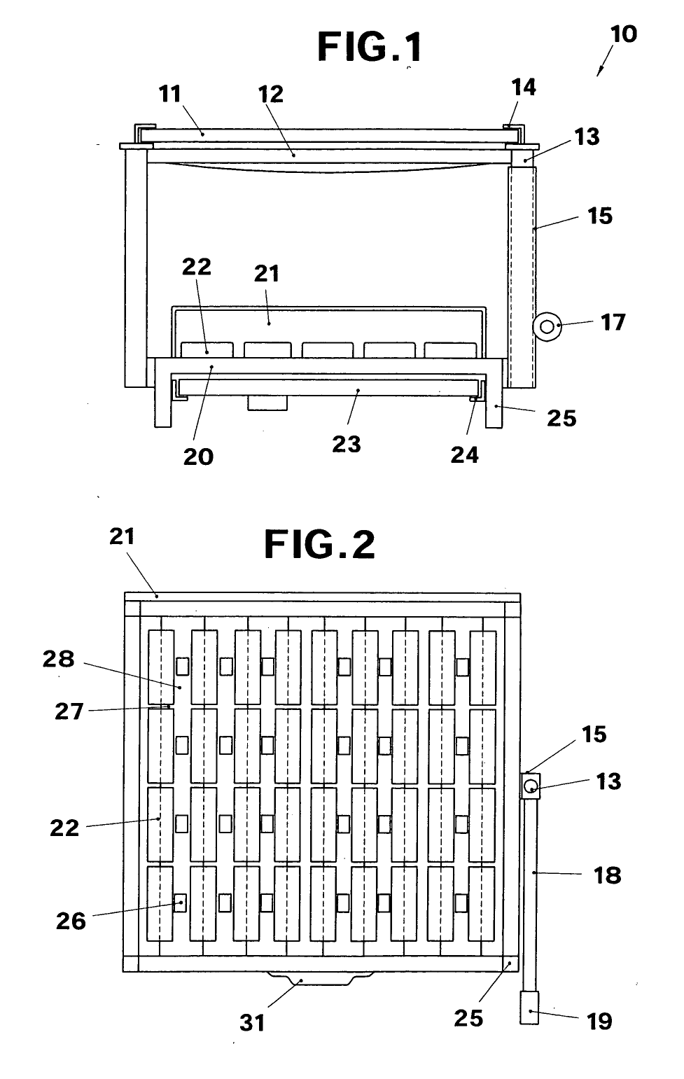

Referring to FIGS. 1-2, a barbecue device 10 in accordance with the present invention includes a grill 11 for supporting food and a lifting member 13 which allows adjustment of the height of grill 11 with respect to the combustible material supported in a tray 20. Lifting member 13 is connected to grill 11 and to tray 20. An ashtray 23 is placed in the lower part of tray 20. A plurality of refractive members 22 are included with the combustible materials as an additional heat source that can provide heat even after the combustible materials have been exhausted.

As seen in FIG. 1, barbecue device 10 is provided with grill 11 including a set of longitudinal bars and a set of transverse bars welded to each other forming a grid onto which food to be cooked is placed. Grill 11 is horizontally fit into angular guides 14 welded perpendicularly to the ends of a support 12 whose length corresponds to the width of the barbecue device 10.

Lifting member 13 includes at least one bar 13 attached to grill 11 via angular guides 14, as seen in FIG. 1. Bar 13 is outwardly threaded to form a screw shaft that is received in an outer cylinder 15. Rotation of bar 13 within outer cylinder 15 results in either upward or downward vertical movement of grill 11. A gear wheel 17 engages the threads of bar 13. A lever 18, as seen in FIG. 2, is mounted to gear wheel 17 and is provided at one end thereof with an insulating member 19. Rotation of lever 18 actuates bar 13 via gear wheel 17 to adjust the height of grill 11. The lifting member allows adjustment of the grill 11 height depending upon the amount of heat desired and the amount of heat provided by the combustible material in tray 20. Also, the need for holding and removing the grill 11 from barbecue device 10 to adjust the height of grill 11 is eliminated. Cleaning of grill 11 is also facilitated since it is not necessary to remove from the grill 11 from barbecue device 10.

Tray 20, as seen in FIG. 1, is made of a series of handrails and is provided with leg members 25 which may be fixed or collapsible depending upon the use of device 10. Ashtray 23 allows ashes of the combustible materials to be removed. Ashtray 23 is supported in the lower part of tray 20 by angular handrails 24 and includes a handle 31. Tray 20 also includes a bed formed of a set of bars which supports refractory members 22.

Refractory members 22 are aligned on tray 20 in even rows and columns, as seen in FIG. 2. Refractory members 22 are separated from each other by spaces 27 between each row of refractory members 22 and spaces 28 between each column of refractory members 22. Catches 26 are located between refractory member 22 in spaces 28. Spaces 27 and 28 allow air to flow past the combustible material while ashes from the combustible material falls from the bed of the tray 20 to ashtray 23, thereby improving combustion. Heat from the combustible material is stored by the refractory members 22, thereby increasing the duration of the heat applied to the food.

Barbecue device 10 is operated by placing the barbecue device 10 on a horizontal surface resting on leg members 25. Grill 11 is removed from guides 14 so that the combustible material can be provided therein. A fire is then lit through suitable means and when the combustible material has converted into ember, the grill 11 is placed back in guides 14. The food can be place on grill 11 before or after grill 11 is placed in guides 14. Refractory members 22 can any material that retains heat, such as brick, clay, kaolin or silica.

The height of grill 11 is adjusted via the lifting member by rotating lever 18 the necessary turns according to the desired amount of heat for cooking the food. Refractive members 22 ensure that the heat applied to the food will be maintained until the food is cooked. Also, refractive members 22 allow the food to be slow cooked. In particular, once the combustion materials have been exhausted, the food can be slow cooked by radiation of the heat stored by the refractory members 22, either by providing the food on grill 11 or arranging the food directly on the refractory members 22.

While a particular embodiment has been chosen to illustrate the invention, it will be understood by those skilled in the art that various changes and modification can be made therein without departing from the scope of the invention as defined in the appended claims.

What is claimed is:

1. A barbecue device, comprising:
a tray supporting combustible material including at least one refractory member adapted to store heat;
a grill disposed above said tray and being connected thereto by a lifting member, said lifting member including a bar slidably received in an outer cylinder,
whereby actuation of said bar with respect to said outer cylinder adjusts the height of grill with respect to said tray.

2. A barbecue device according to claim 1, wherein
a gear engages said bar; and
said gear being connected to a lever so that rotation of said lever actuates rotates said gear to move said bar when adjusting the height of said grill with respect to said tray.

3. A barbecue device according to claim 1, wherein
a plurality of a refractory members are disposed in said tray with spaces located between said refractory members allowing air to flow between said refractory members.

4. A barbecue device according to claim 1, wherein
said tray includes an astray having a handle, and adjustable leg members.

5. A barbecue device according to claim 1, wherein
said grill is horizontally fit between a longitudinal support in angular guides disposed substantially perpendicularly to said support.

6. A barbecue device, comprising
a tray supporting combustible material and including at least one heat source means for retaining heat of the combustible material; and
a grill disposed above said tray and being connected thereto by an adjustment means for adjusting the height of grill with respect to said tray.

7. A barbecue device according to claim 6, wherein
said heat retaining means is a brick.

8. A barbecue device according to claim 6, wherein
said heat retaining means is a plurality of bricks.
